(19) United States
(12) Patent Application Publication
(10) Pub. No.: US 2026/0039475 A1
(43) Pub. Date: Feb. 5, 2026

(54) HARDWARE ROOT OF TRUST USING CONFIGURATION MASKS

(71) Applicant: Siemens Industry Software Inc., Plano, TX (US)

(72) Inventors: Janusz Rajski, West Linn, OR (US); Maciej Trawka, Pruszcz Gdanski (PL); Jerzy Tyszer, Poznan (PL)

(73) Assignee: Siemens Industry Software Inc., Plano, TX (US)

(21) Appl. No.: 19/100,348

(22) PCT Filed: Aug. 8, 2022
(86) PCT No.: PCT/US2022/039716

§ 371 Date: Jan. 31, 2025

(51) Int. Cl. H04L 9/32; H04L 9/08

(52) U.S. Cl. CPC H04L 9/3236; H04L 9/0869

(57) ABSTRACT

A circuit comprises: a random number generator configured to generate a random number: hashing circuitry configured to mimic a hashing function that can transform the random number into a hash value; and retrieving circuitry configured to use the hash value to retrieve one or more configuration masks from a response signal received by the circuit. The response signal is generated based on the random number by a computing device. The generation of the response signal comprises: generating the hash value for the random number, and combining the hash value with the one or more configuration masks. The random number generator may comprise a ring generator and one or more inverter-based ring oscillators configured to inject bits into the ring generator at a plurality of location.

### FIELD OF THE DISCLOSED TECHNIQUES

The presently disclosed techniques relate to the field of hardware security and trust. Various implementations of the disclosed techniques may be particularly useful for designing and using hardware roots of trust to protect circuits against malicious activities and hacking attempts.

### BACKGROUND OF THE DISCLOSED TECHNIQUES

The huge cost of building and maintaining integrated circuit manufacturing has pushed many semiconductor companies to become fabless, outsourcing the expensive fabrication process to foundries. The lack of reliable monitoring and trustworthiness to offshore fabrication and testing processes increases security threats. Hardware security threats can be in many forms including intellectual property (IP) piracy, overproduction, counterfeiting, reverse engineering, and insertion of hardware Trojans.

To mitigate security risks, various defense solutions have been proposed such as logic locking, circuit obfuscation, password-based authentication, challenge-response protocols, and data encryption. The foundation on which many secure operations of an integrated circuit depend is typically defined as a hardware root of trust (RoT). Hardware roots of trust can perform specific, critical security functions. For example, high-end roots of trust are usually integrated into silicon as separate, custom-designed security modules—immune from malware attacks—that handle chip and device identities, cryptographic keys and functions, secure boot processes, attestation, authentication, firmware updates, etc. As a security vehicle, the hardware root of trust should be capable of detecting the intrusion, disabling access pending further actions, and/or obfuscating (camouflaging) logic operations of the IC. Choosing an adequate root of trust depends on many factors, such as a threat model, potential risks, a desired level of protection, programmability, silicon overhead, impact on performance, or the complexity of crypto algorithms and ciphers.

Existing hardware roots of trust are facing many challenges. One challenge is about tradeoffs between meeting security demands and preserving functionality and testability. Another challenge is the complexity of several existing solutions and their impact on area overhead and the design flow. These challenges can make integrated circuit vendors hesitate to adopt the existing solution. An effective and non-intrusive lightweight hardware root of trust is thus highly desirable.

### BRIEF SUMMARY OF THE DISCLOSED TECHNIQUES

Various aspects of the disclosed technology relate to configuration mask-based hardware root of trust schemes. In one aspect, there is a circuit, comprising: a random number generator configured to generate a random number; hashing circuitry configured to mimic a hashing function that can transform the random number into a hash value; and retrieving circuitry configured to use the hash value to retrieve one or more configuration masks from a response signal received by the circuit, wherein the response signal is generated based on the random number by a computing device, the generating comprising: generating the hash value for the random number, and combining the hash value with the one or more configuration masks.

The circuit may further comprise: a controller configured to supervise an authentication process, the authentication process comprising: generating the random number by the random number generator, converting the random number into the hash value by the hashing circuitry, and retrieving, by the retrieving circuitry, the one or more configuration masks from the response signal received by the circuit based on the hash value. The controller may be further configured to supervise a self-testing process. The controller may comprise a finite state machine.

The circuit may further comprise: a descrambler configured to use a configuration mask in the one or more configuration masks to descramble a signal received by the circuit. The descrambling the signal may comprise retrieving compressed test patterns from encrypted compressed test patterns received by the circuit. The compressed test patterns may be transported in the circuit through a data bus.

The circuit may further comprise: a scrambler configured to use a configuration mask in the one or more configuration masks to scramble a signal to be sent out by the circuit. The scrambling the signal may comprise encrypting compacted test responses before being sent out by the circuit.

The random number generator may comprise: a ring generator and one or more inverter-based ring oscillators, the one or more inverter-based ring oscillators configured to inject bits into the ring generator at a plurality of location. At least one of the one or more inverter-based ring oscillators may be configured to inject bits from outputs of some or all inverting elements (inverting devices) in the at least one of the one or more inverter-based ring oscillators. If the one or more inverter-based ring oscillators have more than one inverter-based ring oscillators, the one or more inverter-based ring oscillators may have different numbers of inverting elements and may inject bits into the ring generator at different locations. The random number generator may further comprise: blocking circuitry configured to convert, based on a blocking signal, the ring generator into a circular shift register by blocking both the injection from the one or more inverter-based ring oscillators and internal feedbacks in the ring generator.

The hashing circuitry may comprise: combinational circuitry comprising nonlinear Boolean operators formed by logic gates, the combinational circuitry configured to receive the random number; and a ring generator configured to be initialized by a secret key, to be injected with bits from outputs of the combinational circuitry, and to output the hash value after a predefined number of clock cycles.

The retrieving circuitry may comprise XOR gates.

In another aspect, there are one or more non-transitory computer-readable media storing computer-executable instructions for causing one or more processors to perform a method, the method comprising: creating the above circuit in a circuit design.

Certain inventive aspects are set out in the accompanying independent and dependent claims. Features from the dependent claims may be combined with features of the independent claims and with features of other dependent claims as appropriate and not merely as explicitly set out in the claims.

Certain objects and advantages of various inventive aspects have been described herein above. Of course, it is to be understood that not necessarily all such objects or advantages may be achieved in accordance with any particular embodiment of the disclosed techniques. Thus, for example, those skilled in the art will recognize that the disclosed techniques may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1 illustrates an example of a hardware-root-of-trust system that may be implemented according to various embodiments of the disclosed technology.

FIG. 2A illustrates an example true random number generator that can be used to implement the on-chip random number generator in FIG. 1 according to various embodiments of the disclosed technology.

FIG. 2B illustrates an example true random number generator that can be used to implement the on-chip random number generator in FIG. 1 according to various embodiments of the disclosed technology.

FIG. 3A illustrates an example of a 28-bit ring generator implementing a primitive characteristic polynomial.

FIG. 3B illustrates an example of a 28-bit dense ring generator implementing a primitive characteristic polynomial.

FIG. 4A illustrates an example 28-bit true random number generator based on a 28-bit dense ring generator that may be implemented according to various embodiments of the disclosed technology.

FIG. 4B illustrates an example 32-bit true random number generator based on a 32-bit ring generator that may be implemented according to various embodiments of the disclosed technology.

FIG. 5 illustrates an example 28-bit true random number generator having built-in block circuitry that may be implemented according to various embodiments of the disclosed technology.

FIG. 6 illustrates an example of hashing circuitry that may be used to implement the on-chip hashing circuitry in FIG. 1 according to various embodiments of the disclosed technology.

FIG. 7 illustrates an example combination of a true random number generator and hashing circuitry that may be implemented according to various embodiments of the disclosed technology.

FIG. 8 illustrates an example descrambler that may be implemented according to various embodiments of the disclosed technology.

FIG. 9 illustrates an example of a controller that may be used to implement the controller in FIG. 1 according to various embodiments of the disclosed technology.

FIG. 10 illustrates a flowchart showing a process of generating and applying test patterns to test a circuit having a hardware root of trust that may be implemented according to various examples of the disclosed technology.

FIG. 11 illustrates an example of a 6-core system-on-chip design in which a hardware root of trust secures inputs and outputs of a streaming scan network that may be implemented according to various examples of the disclosed technology.

FIG. 12 illustrates an example of a programmable computer system with which various embodiments of the disclosed technology may be employed.

### DETAILED DESCRIPTION OF THE DISCLOSED TECHNIQUES

Various aspects of the disclosed technology relate to configuration mask-based hardware root of trust schemes. In the following description, numerous details are set forth for the purpose of explanation. However, one of ordinary skill in the art will realize that the disclosed technology may be practiced without the use of these specific details. In other instances, well-known features have not been described in details to avoid obscuring the disclosed technology.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods.

The detailed description of a method or a device sometimes uses terms like “configure,” “generate” and “retrieve” to describe the disclosed method or the device function/structure. Such terms are high-level descriptions. The actual operations or functions/structures that correspond to these terms will vary depending on the particular implementation and are readily discernible by one of ordinary skill in the art.

As used in this disclosure, the singular forms “a,” “an,” and “the” include the plural forms unless the context clearly dictates otherwise. Additionally, the term “includes” means “comprises.” Moreover, unless the context dictates otherwise, the term “coupled” means electrically or electromagnetically connected or linked and includes both direct connections or direct links and indirect connections or indirect links through one or more intermediate elements not affecting the intended operation of the circuit.

Additionally, as used herein, the term “design” is intended to encompass data describing an entire integrated circuit device. This term also is intended to encompass a smaller group of data describing one or more components of an entire device such as a portion of an integrated circuit device nevertheless.

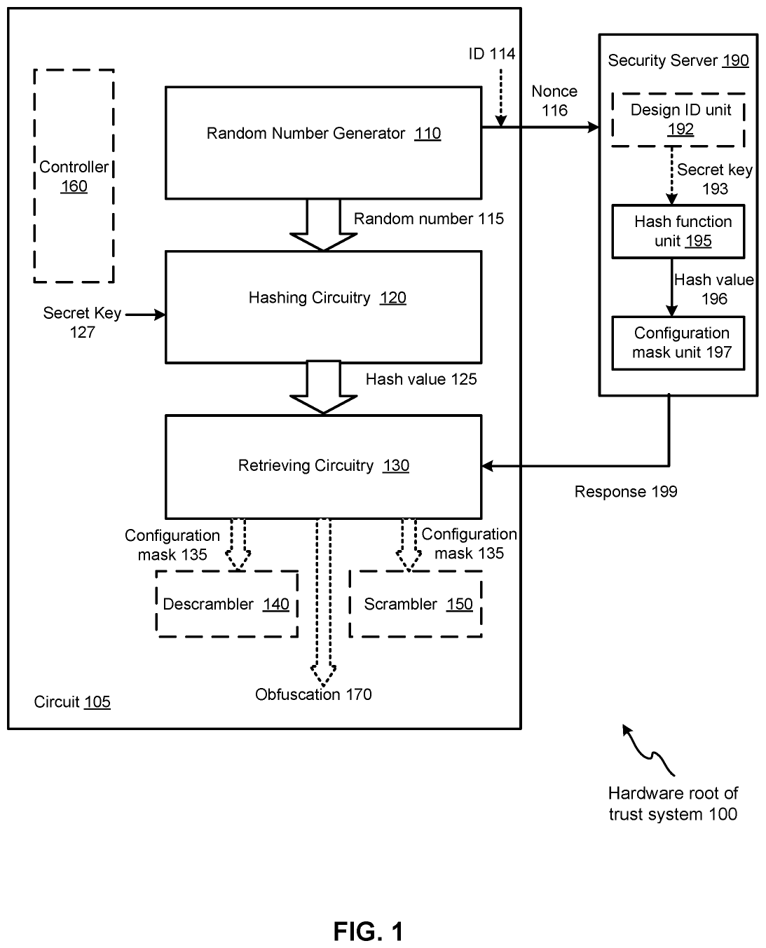

As noted previously, a hardware root of trust is the foundation on which secure operations of a circuit depend, including those related to test. The complexity of conventional hardware root of trust solutions in terms of both area overhead and the impact on the design flow has caused concerns among potential users. FIG. 1 illustrates an example of a hardware-root-of-trust system 100 that may be implemented according to various embodiments of the disclosed technology. The hardware-root-of-trust system 100 comprises components in both a circuit 105 and a security server 190. The components in the circuit 105 comprises a random number generator 110, hashing circuitry 120, and retrieving circuitry 130. The components in the security server 190 comprises a hash function unit 195 and a configuration mask unit 197.

The random number generator 110 in the circuit 105 can be prompted to generate a random number 115. A request received by the circuit 105 to run a certain function, for example, can be set to cause such an action. The circuit 105 then sends to the security server 190 a nonce 116 (sometimes referred to as challenge) formed based on the random number 115. The nonce 116 may contain only the random number 115 or may further contain some individual data from the circuit 105 such as its electronic design identification number 114.

The hashing circuitry 120 in circuit 105 is configured to mimic the same hash function employed by the hash function unit 195 in the security server 190. As such, the hashing circuitry 120 can transform the random number 115 into a hash value 125.

In the security server 190, the hash function unit 195 can use the hash function to compute a hash value 196 for the received nonce 116. In normal operations, the hash value 196 should be the same as the hash value 125. The computation may involve a secret key 193 that is used as an initial value for hashing the random number 115 included in the nonce 116. The security server 190 may further comprise a design identification (Design ID) unit 192. The design identification unit 192 can verify the electronic design identification number 114 and based on it, retrieve the secret key 193 to be used by the hash function unit 195.

If the electronic design identification number 114 is invalid, the security server 190 may still generate a unique and fake initial hash value and use it to obfuscate the resultant response. The security server 190 may also keep track of how many times each individual chip requested a response, monitoring any unusual behavior. The same (valid) secret key 127 can be kept in an encrypted form by the circuit 105 and used by the hashing circuitry 120 in a way similar to how the hash function unit 195 uses the secret key 193.

The configuration mask unit 197 in the security server 190 can combine the hash value 196 with one or more configuration masks to generate a response 199. One example of the configuration masks is a configuration mask that can be employed for descrambling encrypted data into original data. Another example is a configuration mask that can be employed for scrambling original data into encrypted data. With various implementations of the disclosed technology, the configuration mask unit 197 can perform a bit-wise XOR operation combining bits of the one or more configuration masks with bits of the hash value 196. In addition to the one or more configuration masks, other items may also be XORed with the hash value 196. Alternatively or additionally, some bits of the hash value 196 may be left unchanged.

After the circuit 105 receives the response 199 from the security server 190, the retrieving circuitry 130 can use the hash value 125 received from the hashing circuitry 120 to retrieve the one or more configuration masks 135 from the response 199. If the one or more configuration masks 135 are XORed with the hash value 196 in a bitwise operation by the configuration mask unit 197 as described above, the retrieving circuitry 130 can use XOR gates to perform a bitwise retrieving operation.

The circuit 105 may further comprise a descrambler 140, a scrambler 150, or both. The descrambler 140 can use one of the one or more configuration masks 135 to retrieve original data from encrypted data received by the circuit 105. For example, the descrambler 140 can be configured to retrieve compressed test patterns from encrypted compressed test patterns received by the circuit 105. The scrambler 150 can use another one of the one or more configuration masks 135 to encrypt data that need to be sent out by the circuit 105. For example, the scrambler 150 can be configured to encrypt test responses or compacted test response before they are sent out by the circuit 105 for analysis.

An attempt to unauthorized access may trigger twofold changes in the circuit internal functionality if both the descrambler 140 and the scrambler 150 are in the circuit 105. First, the descrambler 140 and the scrambler 150 become blurred due to corrupted configuration masks. Second, the remaining bits (obfuscation 170) of the response 199 if any can be used to hide design functionality from adversaries in the process of logic obfuscation. The logic obfuscation can result in signal corruptions caused by activation of certain elements. Alternatively, any mismatch between some bits of the hash value 125 and the hash value 196 may launch a simple logic locking scheme, disabling access to the genuine functionality of the circuit 105.

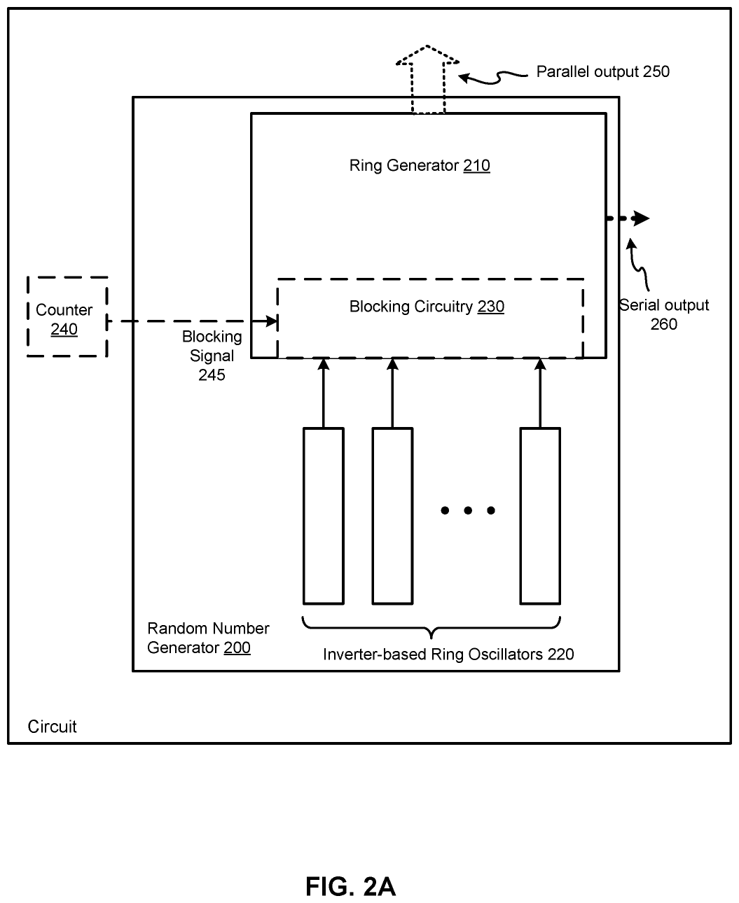

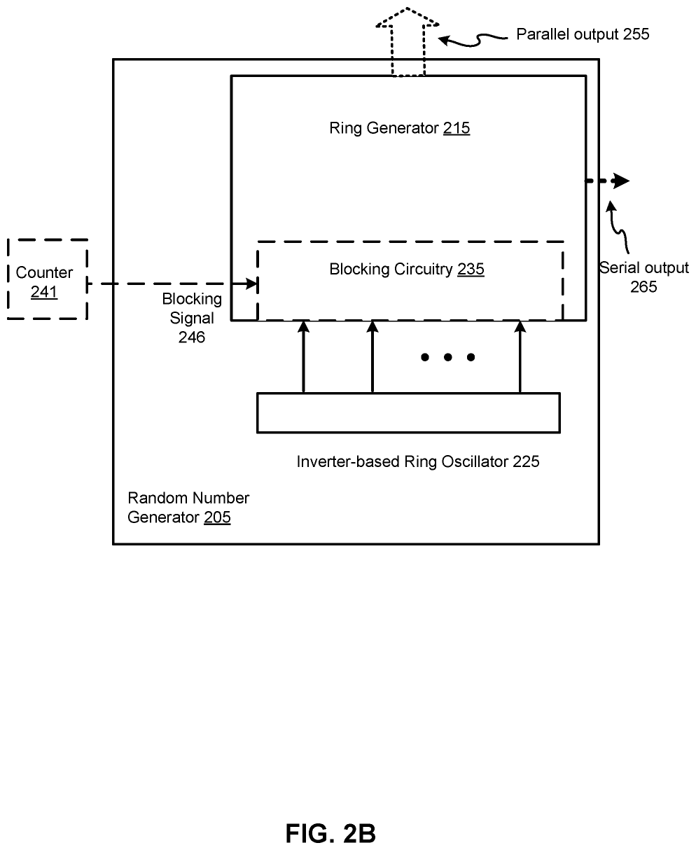

Random number generators are one of the important hardware security primitives for hardware root of trust. From the security perspective, random numbers generated by pseudorandom number generators can be secure against some brute-force attacks due to the large pattern space. True random number generators, however, can be more effective against security risks since pseudorandom number generators have deterministic output patterns which are still vulnerable to cryptanalytic attacks. FIG. 2A illustrates an example true random number generator 200 that can be used to implement the on-chip random number generator 110 in FIG. 1 according to various embodiments of the disclosed technology. The true random number generator 200 comprises a ring generator 210 and a plurality of inverter-based ring oscillators 220. Both the ring generator 210 and the plurality of inverter-based ring oscillators 220 can be constructed using digital components. Each of the plurality of inverter-based ring oscillators 220 is configured to inject bits into the ring generator 210 at a unique location. With various implementations of the disclosed technology, each of the plurality of inverter-based ring oscillators 220 may comprise a unique number of inverting elements (inverting devices). Examples of the inverting elements are NOT gates and NAND gates.

The ring generator 210 can produce a sequence of pseudorandom numbers by itself. The injections from the plurality of inverter-based ring oscillators 220 transform the ring generator 210 into a true random number generator. Each of the plurality of inverter-based ring oscillators 220 injects the logic value of 1 into the ring generator 210 with a frequency that depends on the integrated circuit fabrication process and the number of inverting elements used. The stochastic characteristics present in the integrated circuit fabrication process thus supplies desired uncertainty (entropy) or randomness. Further, since the clocking of the ring generator 210 is inherently asynchronous to the state of every ring oscillator 220, many clock samples may also stress the metastable region of the flip-flops of the ring generator 210 (due to setup and hold time violations), thereby producing an additional randomness.

FIG. 2B illustrates another example true random number generator 205 that can be used to implement the on-chip random number generator 110 in FIG. 1 according to various embodiments of the disclosed technology. The true random number generator 205 comprises a ring generator 215 and an inverter-based ring oscillator 225. Both the ring generator 215 and the inverter-based ring oscillator 225 can be constructed using digital components. The inverter-based ring oscillator 225 is configured to inject bits into the ring generator 215 at multiple locations from outputs of multiple selected inverting elements in the inverter-based ring oscillator 225.

The inverter-based ring oscillator 225 operates with a frequency that depends on the circuit fabrication process, the number of logic elements it deploys, and the delay of its routing path. Sampling many inverters can populate a relatively long interval with the timing jitter, hence maximizing the probability that at least one noisy signal edge is captured in the ring generator 215. Consequently, the ring generator 215 acts as a special form of a bit extractor processing data collected at several stages of the inverter-based ring oscillator 225. Furthermore, since the clocking of the ring generator 215 is inherently asynchronous to the state of the inverter-based ring oscillator 225, some clock samples may stress the metastability region of the ring generator flip-flops (due to setup and hold time violations), thereby producing an additional uncertainty (entropy) or randomness.

Ring generators are a type of linear finite state machines, which can be derived by altering the canonical forms (external feedback, internal feedback) of linear feedback shift registers while maintaining their transition functions. An example of the altering is the m-sequence preserving transformations described in G. Mrugalski, J. Rajski, J. Tyszer, “Ring Generators—New Devices for Embedded Test Applications,” IEEE Trans. Computer-Aided Design, vol. 23, no. 9, pp. 1306-1320, 2004. Like linear feedback shift registers, ring generators can be used in various circuit test applications such as pseudorandom test pattern generation, on-chip test data decompression, and test response compaction. It has been shown that after applying the transformations to linear feedback shift registers in a certain order, the resultant ring generators feature a significantly reduced number of levels of XOR logic, minimized internal fan-outs, and simplified circuit layout and routing, as compared to conventional linear feedback shift registers and cellular automata. Consequently, ring generators have highly modular structures and can operate at high speeds.

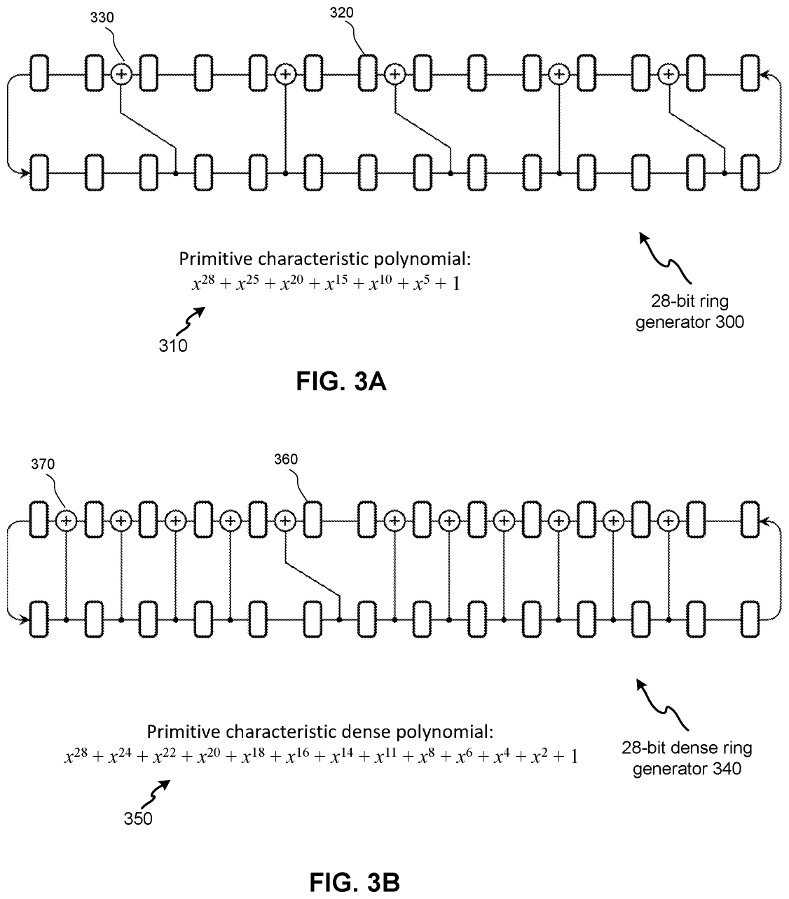

FIG. 3A illustrates an example of a 28-bit ring generator 300 implementing a primitive characteristic polynomial 310. The 28-bit ring generator 300 comprises twenty-eight state elements 320 and five XOR gates 330. Each of the XOR gates 330 is located at a feedback location in a ring formed by the state elements 320 and one of its input connects to a feedback tap via a feedback line. The state elements 320 can be implemented using flip-flops. As the figure shows, the feedback logic for the 28-bit ring generator 300 has only one two-input XOR gate per feedback line, so the number of levels of logic is 1, smaller than 2 and log₂k for a cellular automaton and the external feedback form of linear feedback shift registers (k is the number of XOR gates), respectively. Also as indicated by the figure, the 28-bit ring generator 300 does not use long feedback lines which are needed in the internal feedback form of linear feedback shift registers. Therefore, ring generators are faster than both the two canonical forms of linear feedback shift registers and cellular automata.

FIG. 3B illustrates an example of a 28-bit dense ring generator 340 implementing a primitive characteristic polynomial 350. The 28-bit dense ring generator 340 comprises twenty-eight state elements 360 and eleven XOR gates 370. The large number of XOR gates 370 leads to the dense characteristic polynomial 350 which has thirteen non-zero terms, compared to seven non-zero terms of the primitive characteristic polynomial 310. Dense ring generators, when used for test data decompression, are capable of driving a large number of scan chains by using either outputs taken directly from the feedback logic or phase shifters that are tapped locally from consecutive locations. This can allow designers to minimize routing complexity, optimize wire sizing, and make the overall layout compact. It should be noted that either conventional ring generators like the 28-bit ring generator 300 or dense ring generators like the 28-bit dense ring generator 340 can be used to implement the ring generator 210 in FIG. 2A and the ring generator 215 in FIG. 2B.

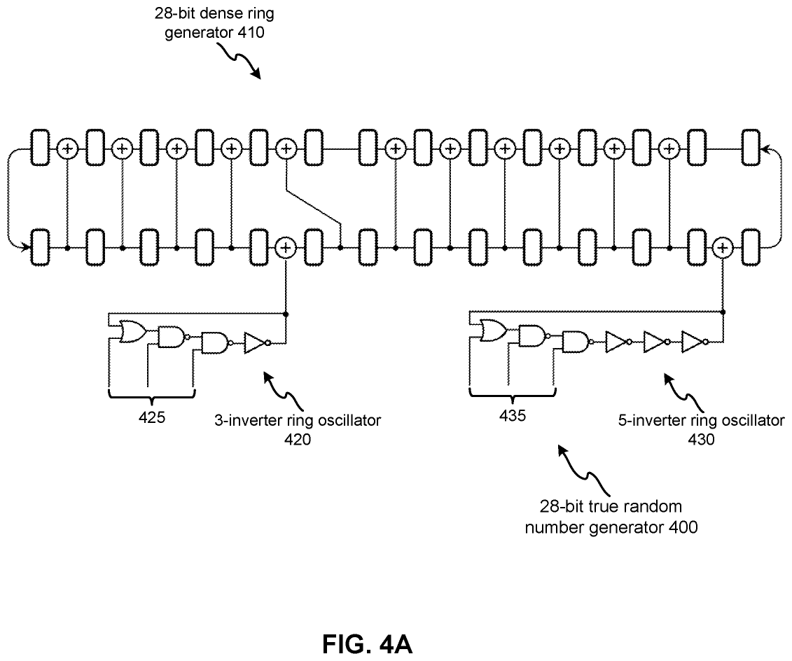

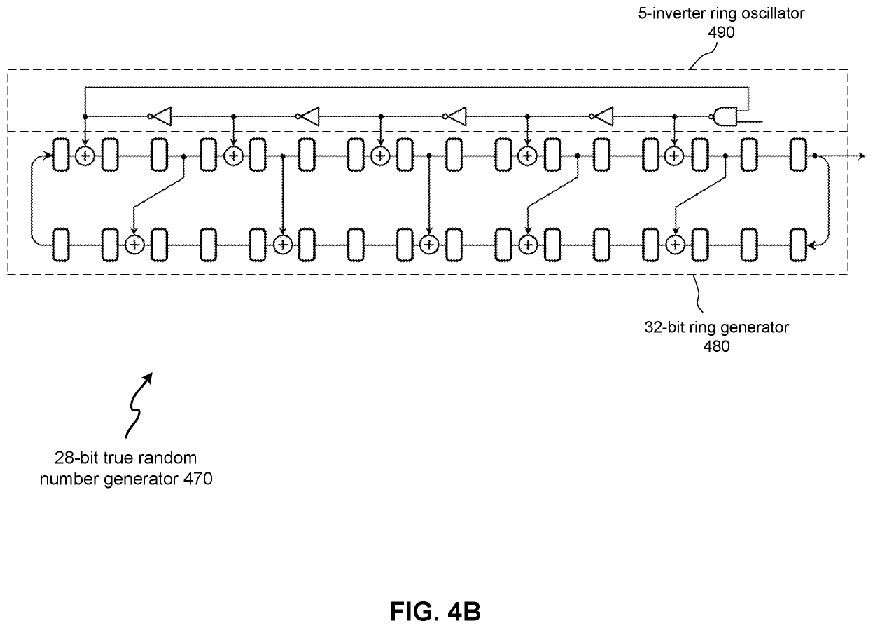

FIG. 4A illustrates an example 28-bit true random number generator 400 based on a 28-bit dense ring generator 410 that may be implemented according to various embodiments of the disclosed technology. The 28-bit dense ring generator 410 is the same as the 28-bit dense ring generator 340 in FIG. 3B. In addition to the 28-bit dense ring generator 410, the 28-bit true random number generator 400 comprises a 3-inverter ring oscillator 420 and a 5-inverter ring oscillator 430. The 3-inverter ring oscillator 420 and the 5-inverter ring oscillator 430 can inject bits into the 28-bit dense ring generator 410 through XOR gates at two different locations, respectively. Different numbers of inverting elements may enhance randomness of the generated sequences of random numbers. Input 425 for the 3-inverter ring oscillator 420 and inputs 435 for the 5-inverter ring oscillator 430 can be used to apply test stimuli for testing these ring oscillators.

FIG. 4B illustrates an example 32-bit true random number generator 470 based on a 32-bit ring generator 480 that may be implemented according to various embodiments of the disclosed technology. In addition to the 32-bit ring generator 480, the 32-bit true random number generator 470 comprises a 5-inverter ring oscillator 490. The outputs of five inverting elements (four inverters and one NAND gate) of the 5-inverter ring oscillator 490 can inject bits into the 32-bit ring generator 480 through XOR gates at five different locations, respectively. It should be noted that in some embodiments of the disclosed technology, not all outputs of the inverting elements are used for injecting bits into the ring generator.

Referring back to FIG. 2A, the true random number generator 200 may further comprise blocking circuitry 230 configured to convert, based on a blocking signal 245, the ring generator 210 into a circular shift register by blocking both the injection from the plurality of inverter-based ring oscillators 220 and internal feedbacks in the ring generator 210. The blocking signal 245 can be configured to change from unblocking to blocking when the content of the ring generator 210 is ready to be sent out. Typically, the change occurs after a predefined number of clock cycles dictated by a counter 240. The counter 240 can be inside or outside a controller. The content of the ring generator 210 can be sent out via a serial output 260, a parallel output 250, or both.

Similar to the true random number generator 200, the true random number generator 205 in FIG. 2B may further comprise blocking circuitry 235 configured to convert, based on a blocking signal 246, the ring generator 215 into a circular shift register by blocking both the injection from the inverter-based ring oscillator 225 and internal feedbacks in the ring generator 215. The counter 241 can supply the blocking signal 246. The counter 241 can be inside or outside a controller. The content of the ring generator 2615 can be sent out via a serial output 265, a parallel output 255, or both.

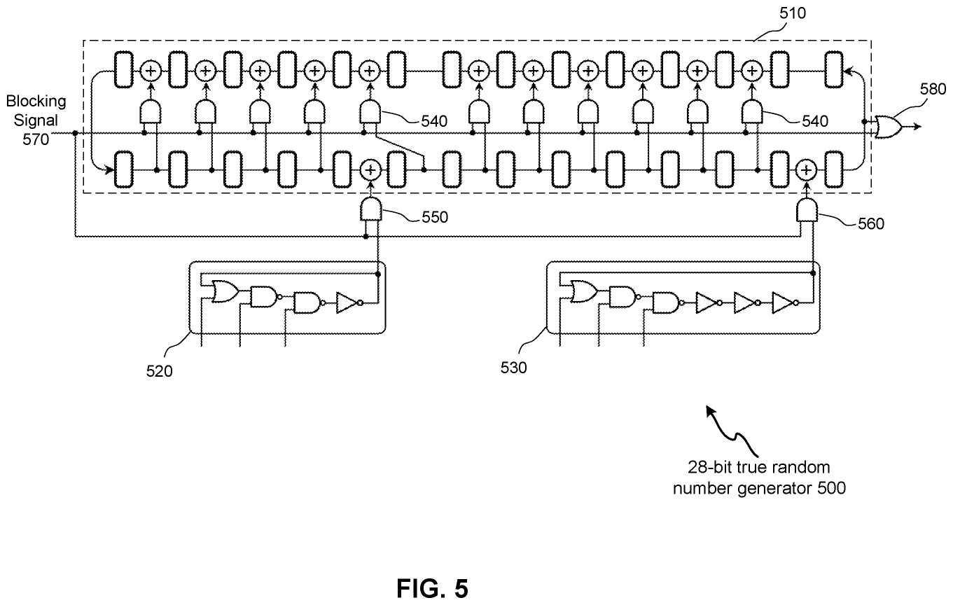

FIG. 5 illustrates an example 28-bit true random number generator 500 having built-in block circuitry that may be implemented according to various embodiments of the disclosed technology. Like the 28-bit true random number generator 400 in FIG. 4A, the 28-bit true random number generator 500 comprises a 28-bit dense ring generator 510, a 3-inverter ring oscillator 520, and a 5-inverter ring oscillator 530. Further, the 28-bit true random number generator 500 comprises eleven AND gates 540, one on each of the feedback lines of the 28-bit dense ring generator 510, an AND gate 550 gating the output of the 3-inverter ring oscillator 520, and an AND gate 560 gating the output of the 5-inverter ring oscillator 530. These AND gates 540, 550 and 560 form the block circuitry and are controlled by a blocking signal 570. When the blocking signal 570 is “1”, the 28-bit dense ring generator 510 operates as a ring generator with injections from the 3-inverter ring oscillator 520 and the 5-inverter ring oscillator 530. When the blocking signal 570 is changed to “0”, the 28-bit dense ring generator 510 becomes a circular shift register and its content can be shifted out through an OR gate 580. Some outputs of the state elements of the 28-bit dense ring generator 510 can be configured to serve as the parallel output of the 28-bit true random number generator 500.

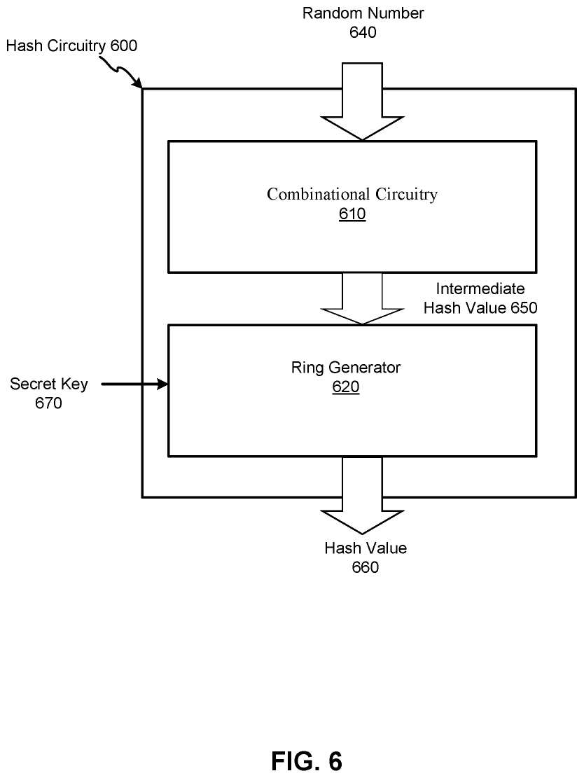

Another one of the important hardware security primitives for hardware root of trust is the hashing circuitry. The on-chip hashing circuitry is preferable to be easily designed, synthesized, and implemented with modern digital design blocks. FIG. 6 illustrates an example of hashing circuitry 600 that may be used to implement the on-chip hashing circuitry 120 in FIG. 1 according to various embodiments of the disclosed technology. The hashing circuitry 600 comprises combinational circuitry 610 and a ring generator 620. The combinational circuitry 610 comprises logic gates and can be taken from a class of hash functions. Each member of the class comprises a number of nonlinear Boolean operators as well as simple logic functions in their canonical forms. Selection of a particular hash function can be decided on the basis of the size of random number 640 and the ring generator 620. The combinational circuitry 610 can transform the random number 640 into an intermediate hash value 650. The ring generator 620 can mutate the intermediate hash value 650 and transform it into a hash value 660. During a hashing process, the ring generator 620 is first initialized by a secret key 670. The secret key 670 may be stored in an encoded form in a nonvolatile on-chip tamper-proof memory. The secret key 670 can be serially uploaded into the ring generator 620 prior to the actual hashing clock cycles. After the initialization, bits of the intermediate hash value 650 are injected into the ring generator 620 from outputs of the combinational circuitry 610. During the injection process, several bits of the intermediate hash value 650 are continuously available at the outputs of the combinational circuitry 610. After a predefined number of clock cycles that suffice to rotate the content of the ring generator 620 multiple times, the hash value 660 is finalized and ready to be used for subsequent applications. The ring generator 610 can be implemented by using either conventional ring generators like the 28-bit ring generator 300 in FIG. 3A or dense ring generators like the 28-bit dense ring generator 340 in FIG. 3B.

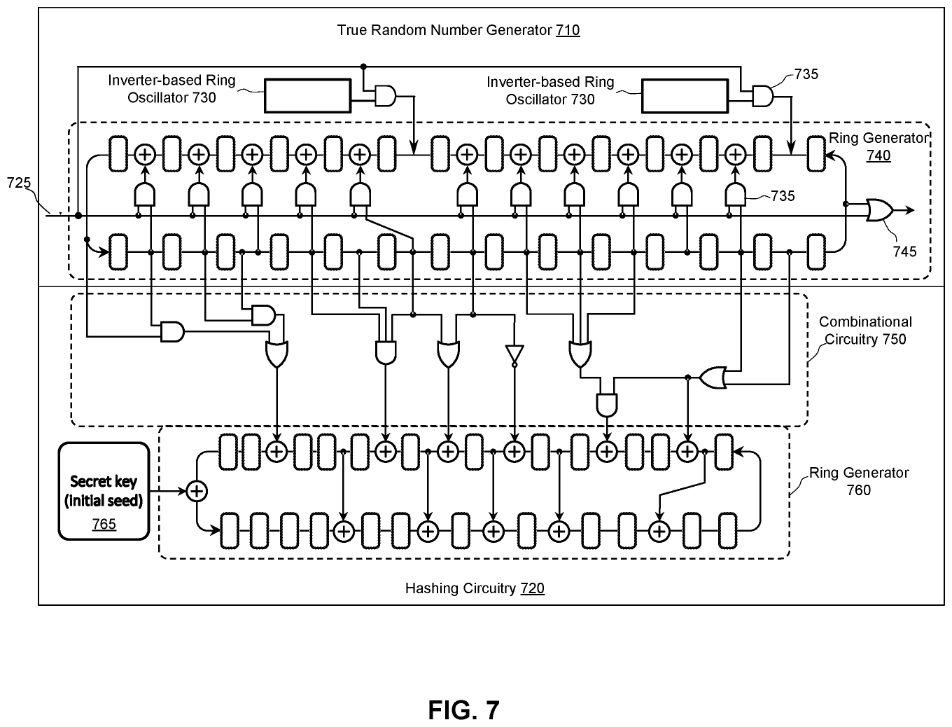

FIG. 7 illustrates an example combination of a true random number generator 710 and hashing circuitry 720 that may be implemented according to various embodiments of the disclosed technology. The true random number generator 710 comprises a ring generator 740, two inverter-based ring oscillators 730, blocking circuitry formed with thirteen AND gates 735, and an OR gate 745 configured to control a serial output of the true random number generator 710. The ring generator 740 is a 28-bit dense ring generator, similar to the 28-bit dense ring generator 340 in FIG. 3B. The two inverter-based ring oscillators 730 may be implemented by two ring oscillators having different numbers of inverting elements such as the 3-inverter ring oscillator 520 and the 5-inverter ring oscillator 530 shown in FIG. 5.

When a blocking signal 725 is changed to the logic value of zero, the AND gates 735 transforms the ring generator 740 into a circular shift register by blocking both the injection from the inverter-based ring oscillators 730 and internal feedbacks in the ring generator 740. Typically, the change occurs after a predefined number of clock cycles which can be controlled by a counter (not shown in the figure). The blocking signal 735 can also control the serial output of the true random number generator 710 via the OR gate 745. The serial output can be used to form a nonce which is sent to a security server outside the chip.

The hashing circuitry 720 comprises combinational circuitry 750 and a ring generator 760. The combinational circuitry 750 comprises AND gates, OR gates, and an inverter, and has 13 inputs and 6 outputs. The combinational circuitry 750 is configured to use bits outputted from the ring generator 740 to produce an intermediate hash value after the blocking signal 735 transforms the ring generator 740 into a circular shift register. The transformation spans over several stages of this circular shift register. The final hash value is formed by the ring generator 760. As discussed previously, a secret key 765 is used to initialize the ring generator 760 prior to the actual hashing clock cycles, and the ring generator 760 can then mutate the intermediate hash value based on a primitive feedback polynomial it employs. The hashing process performed in the ring generator 760 comprises injecting several bits that are continuously available at the six outputs of the combinational circuitry 750 and rotating the content of the ring generator 760 multiple times. This can be controlled by a counter which is not shown in FIG. 7. This counter can be the same counter used to control the change of the blocking signal 725. It should be noted that there may be other control circuitry in addition to the counter, of which some components may be placed between and/or within each of the true random number generator 710 and the hashing circuitry 720.

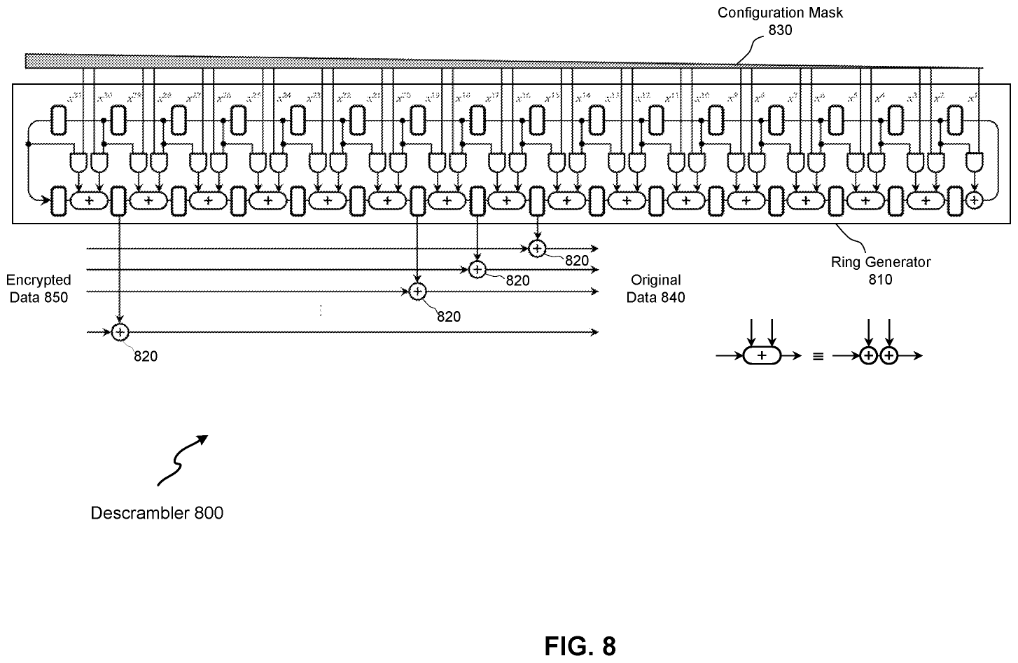

FIG. 8 illustrates an example descrambler 800 that may be implemented according to various embodiments of the disclosed technology. The descrambler 800 comprises a 32-bit ring generator 810 and XOR gates 820 and uses the principle of the Vernam stream cipher. Bits of a configuration mask 830 are injected into the 32-bit ring generator 810 through its feedback lines. The XOR gates 820 use the pseudorandom sequences produced by the 32-bit ring generator 810 to retrieve original data 840 from encrypted data 1150. As discussed previously, a ring generator can operate at a high speed, enabling a ring-generator-based descrambler to work with other high-speed circuitry in the circuit. Further, the modular and programmable feedback network properties of a ring generator allow various characteristic polynomials to be implemented. This, in turn, allows one to pick a suitable secret configuration mask that may correspond to a primitive polynomial depending on other security needs.

A scrambler can use the same principles described above. A configuration mask for scrambling is injected into a ring generator in the same way as the configuration mask 830. Bits of the data to be scrambled are XORed with bits of the pseudorandom sequences produced by the ring generator. For scrambling, the locations for the encrypted data 850 and the original data 840 are switched.

An attempt to unauthorized access is detected when the response from the security server does not match what is expected. The detection can lead to a wrong descrambling mask. The wrong descrambling mask can trigger a peculiar feedback polynomial that is going to yield a pseudorandom sequence (even not necessarily a maximum-length on its own) that can effectively blur encrypted input data. The scrambler can obscure output data following the same principles.

Referring back to FIG. 1, the circuit 105 may further comprise a controller 160 configured to control the security components in the circuit 105 such as the random number generator 110, the hashing circuitry 120, and/or the retrieving circuitry 130. The controller 160 can be implemented using a simple finite-state machine. As discussed previously, the random number generator 110 may need a preset number of clock cycles before it is ready to output the random number 115. The hashing circuitry 120 may also need at least a certain number of clock cycles before the hash value 125 is finalized and ready to be used for subsequent applications. Accordingly, the controller 160 can include a counter to determine the time needed in the operations of the random number generator 110 and the hashing circuitry 120. In addition to the finite-state machine and the counter, the controller 160 can comprise other components for additional functions such as self-testing.

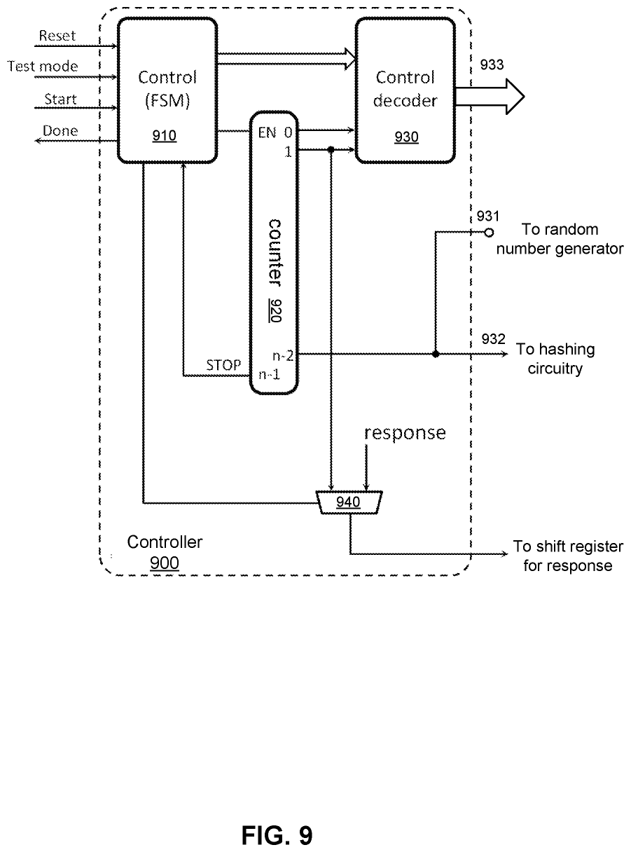

FIG. 9 illustrates an example of a controller 900 that may be used to implement the controller 160 in FIG. 1 according to various embodiments of the disclosed technology. The controller 900 comprises a control unit 910, a counter 920, a control decoder 930, and a multiplexer 940. The control unit 910 can be implemented using a finite-state machine circuit (FSM). The counter 930 can control, through outputs 931 and 932, respectively, activity periods of both the random number generator and the hashing circuitry. The counter 930 can also signal the control unit 910 when its most significant output bit changes from 0 to 1, which can be used to terminate operations. The multiplexer 940 and the control decoder 930 can be used for self-testing. For example, the control decoder 930 may be configured to provide stimuli for testing ring oscillators in a true random number generator. The multiplexer 940 can allow sequences from the counter 930 as test stimuli to test a shift register that is typically employed to store the response from the security server.

Scan-based circuit testing is a type of structural testing and has been widely adopted. One major advantage of structural testing is that it enables the test generation to focus on testing a limited number of relatively simple circuit elements rather than having to deal with an exponentially increasing multiplicity of functional states and state transitions. Despite efficient automatic test pattern generation (ATPG) and design for test (DFT schemes, new test challenges keep surfacing. Unprecedentedly small technology nodes with the corresponding new fault models have caused the explosive pace of test data growth. The test community responded to these challenges with the introduction of test data compression. Test data compression can significantly reduce the cost of test and has a significant impact on the test landscape. According to this paradigm, a tester (typically automatic test equipment (ATE)) stores compressed test patterns and delivers them to an on-chip decompressor, which drives scan chains with the actual test stimuli. Similarly, test responses are shifted out via scan chains to an on-chip compactor and sent back to the tester for further processing. This approach reduces test application time, ATE memory, and I/O channels. To address system-on-chip-related challenges, various techniques that deliver test data to circuit blocks through a data bus have recently been developed. One example is the streaming scan network (SSN) technique, which enables high-speed data distribution and efficient handling of imbalances between successive circuit blocks.

Despite a seminal significance of scan-based test solutions, the very same schemes may provide an unrestricted access to the internal states of a circuit under test, and thus they may open a backdoor for serious security threats. An attacker may shift in corrupted data (controllability attacks) and shift out confidential data (observability attacks). These so-called scan-based attacks may not be feasible provided switching between functional and test modes is disabled. However, fussing off a test interface impedes more advanced operations, including debugging, post-firmware-upgrade tests, diagnosis of field returns, or in-system and in-field test applications. With the advent of test compression, additional on-chip test infrastructure as well as encoded test data make a circuit more resistant to scan attacks. Unfortunately, test compression facilities may not be as effective countermeasures to scan-launched attacks as one might expect. The development of streaming scan network can form another defense line to protect complex designs against malicious activities and hacking attempts. Nevertheless, it remains essential to apply access restrictions and to secure test infrastructure of a device-under-test to prevent leakage of any secret information while tests are carried out.

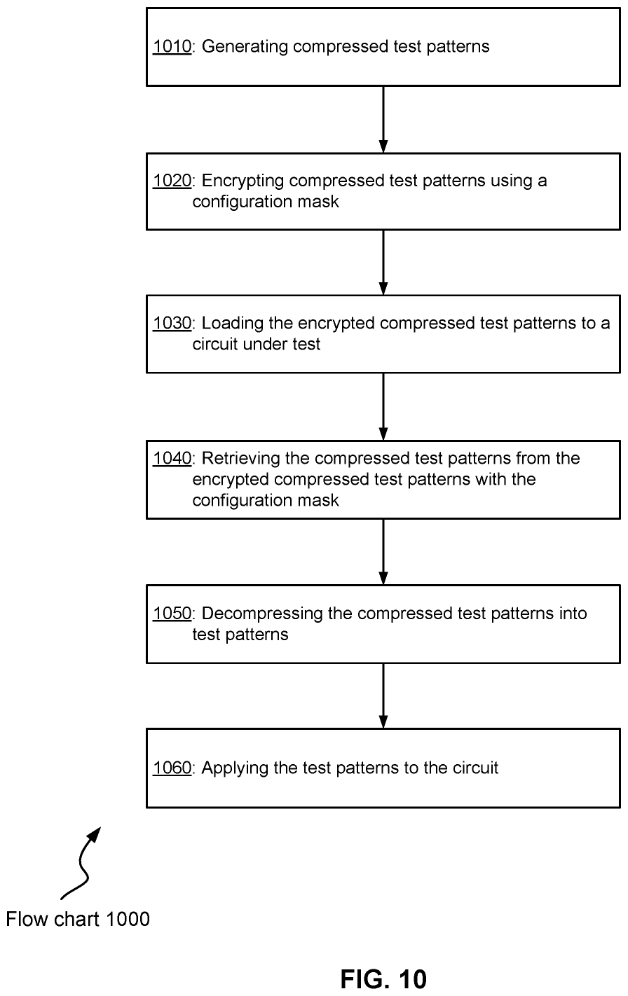

The disclosed technology can be used to mitigate the security risks associated with test infrastructure. FIG. 10 illustrates a flowchart 1000 showing a process of generating and applying test patterns to test a circuit having a hardware root of trust that may be implemented according to various examples of the disclosed technology. In operation 1010, compressed test patterns are generated by one or more computing systems. Test patterns for scan testing are typically generated through an automatic test pattern generation (ATPG) process. ATPG usually focuses on a set of faults derived from a gate-level fault model. A defect is a flaw or physical imperfection caused in a device during the manufacturing process. A fault model (or briefly a fault) is a description of how a defect alters design behavior. For a given target fault, ATPG comprises two phases: fault activation and fault propagation. Fault activation establishes a signal value at the fault site opposite that produced by the fault. Fault propagation propagates the fault effect forward by sensitizing a path from a fault site to a scan cell or a primary output. A fault at a site is said to be detected by a test pattern if a test response value captured by a scan cell or a primary output is different than the expected value.

Test patterns generated by an ATPG process can be compressed mainly because only 1% to 5% of test pattern bits are typically specified bits (care bits) while the rest are unspecified bits (don't-care bits). Unspecified bits can take on any values with no impact on the fault coverage. Test compression may also take advantage of the fact that test cubes tend to be highly correlated. A test cube is a deterministic test pattern in which the don't-care bits are not filled by ATPG. The correlation exists because faults are structurally related in the circuit. Various test compression techniques have been developed. The embedded deterministic test (EDT) is an example test compression technique. The EDT compression of test cubes is performed by treating the external test data as Boolean variables. Scan cells are conceptually filled with symbolic expressions that are linear functions of input variables injected into the decompressor. In the case of a decompressor comprising a ring generator and an associated phase shifter, a set of linear equations corresponding to scan cells whose values are specified may be used. A compressed pattern can be determined by solving the system of equations. Test pattern generation and test pattern compression may be performed in sequence by the same or different computing systems. Alternatively, the two processes can be performed concurrently. For example, whether a test cube is compressible or encodable is determined while test cubes are generated.

In operation 1020, the compressed test patterns are encrypted using a configuration mask by a computing system. This computing system can be the same as or different from those used in the prior operation. One way to encrypt the compressed test patterns is to XOR the compressed test patterns with bits produced from the configuration mask in a bitwise operation. As discussed previously, a circuit made according to the principle of the descrambler 800 in FIG. 8 can be used to encrypt data using a configuration mask. The computing system in the present operation can mimic such an operation of the circuit to produce encrypted compressed test patterns.

In operation 1030, the encrypted compressed test patterns are loaded into a circuit under test by a tester such as an automatic test equipment (ATE).

In operation 1040, the compressed test patterns are retrieved from the encrypted compressed test patterns with the configuration mask by a descrambler of the hardware root of trust in the circuit under test. The descrambler can be implemented using the descrambler 800 in FIG. 8. The configuration mask is encrypted in a response that is delivered to the circuit under test by a security server. The security server can use a hash value to encrypt the configuration mask. The hash value is generated by the security server in response to a nonce received from the circuit under test. After the response being delivered to the circuit under test, the retrieving circuitry of the hardware root of trust in the circuit under test retrieves the configuration mask from it. The whole hardware root of trust can be implemented using the hardware root of trust system 100 in FIG. 1.

In operation 1050, the compressed test patterns are decompressed into test patterns by a decompressor in the circuit under test. In the EDT-based compression scheme, the decompressor can comprise a ring generator and an associated phase shifter.

In operation 1060, the test patterns are applied to the circuit via scan chains. The operations 1050 and 1060 can be conducted concurrently. After a first compressed test pattern is decompressed and shifted into the circuit, a second compressed test pattern is loaded into the decompressor. After the test response for the first decompressed test pattern is captured by the scan chains, the decompressed second test pattern is being shifted into the scan chains while the test response is being shifted out and the third compressed test pattern is being loaded into the decompressor. The above process continues until all of the test patterns are applied to the circuit under test.

As noted previously, data-bus-based test data delivery such as the streaming scan network can be employed to cope with the enormous complexity of system-on-chips in an automated and scalable manner and to address various test problems in a hierarchical fashion. In particular, the streaming scan network can resolve system-on-chip test problems that include an inability to drive the growing number of cores concurrently due to limited chip pin counts, different scan lengths, different pattern counts, or internal shift speed constraints limiting the ability to shift data in and out of the chip at the high rates. Furthermore, the streaming scan network can facilitate a balanced broadcasting of test data to identical cores without incurring inefficient test time, high planning efforts, and physical design/timing closure issues.

Although the streaming scan network solves many scan data distribution challenges in large system-on-chip or 3D designs, it might be vulnerable to certain kinds of attacks for the same or similar reasons as those observed in conventional scan-based designs. The streaming scan network technology can be secured by adding a die-centric hardware root of trust protecting streaming scan network-based designs against unauthorized access and expanding threatscape. As the streaming scan network is compatible with a flexible parallel port of IEEE Std 1838 for 3D test access, the hardware root of trust can take advantage of its central DFT entry to protect a single top level test access point shared by IEEE 1687 (IJTAG) compliant IP blocks. In 3D integrated circuits, the hardware root of trust can be either assigned to every silicon wafer or to a master die only.

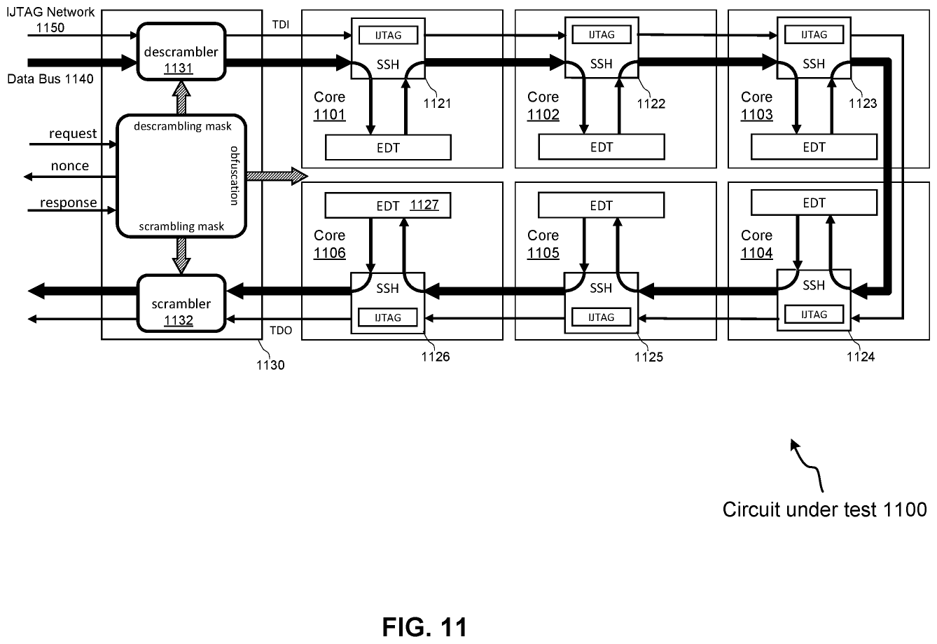

FIG. 11 illustrates an example of a 6-core system-on-chip design 1100 in which a hardware root of trust 1130 secures inputs and outputs of a streaming scan network that may be implemented according to various examples of the disclosed technology. The streaming scan network comprises a parallel data bus 1140 configured to convey the payload scan data and a single-bit IEEE 1687 IJTAG network 1150 used to configure streaming scan network nodes prior to application of test patterns. The streaming scan network further comprises streaming scan host (SSH) 1121-1126, one for each of six cores 1101-1106 of the system-on-chip design 1100, driving local scan resources to load and unload scan chains (or channels) with data delivered on the parallel data bus 1140. For example, the streaming scan host 1126 can interface with EDT logic 1127.

Typically, each of the streaming scan hosts 1121-1126 has two external ports to interface with the parallel data bus 1140 and the IEEE 1687 IJTAG network 1150, respectively. Via the IJTAG network 1150, each of the streaming scan hosts 1121-1126 is preloaded with data regarding the active bus width, its location in the series of nodes driven, the number of shift cycles per scan pattern, and other information needed to track the streaming operations. Following this setup, compressed test patterns can be applied as packetized scan data that are streamed through the streaming scan hosts 1121-1126 via the parallel data bus 1140. Each of the six streaming scan hosts 1121-1126 can determine when it needs (1) to read scan in data from the bus, (2) to place scan out data on the bus, or (3) to pass along data that is destined for other nodes.

The hardware root of trust 1130 comprises a descrambler 1131 and a scrambler 1132 installed on inputs and outputs of the streaming scan network, respectively. Both devices can decrypt/encrypt the content of the parallel data bus 1140 and the IJTAG network 1150. As a result, they form, in conjunction with the root-of-trust controller and its access authentication mechanisms, effective barriers that may obscure many control and data signals, and thus prevent a wide spectrum of attempts to compromise a design. In the case of unauthorized access, randomly obfuscated test data produced by both the descrambler 1131 and the scrambler 1132 will cause the 6-core system-on-chip design 1100 to enter an unusual test mode. In this mode, the DFT logic architecture becomes completely unpredictable, leaving the attacker confused or given a fake feedback. Moreover, the same signals may trigger other internal on-chip mechanisms which do not allow normal IP behavior.

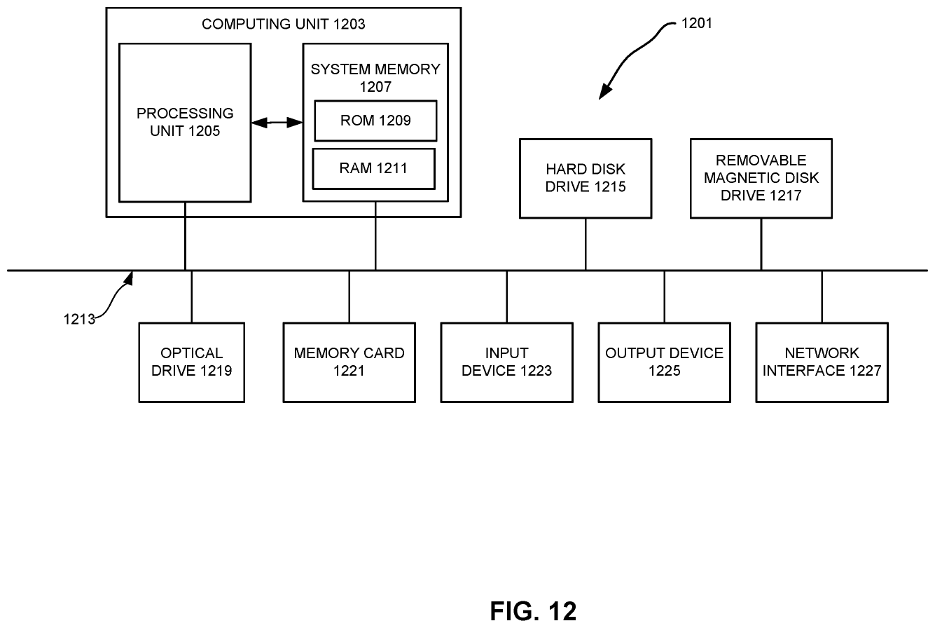

Various examples of the disclosed technology may be implemented through the execution of software instructions by a computing device, such as a programmable computer. Accordingly, FIG. 12 shows an illustrative example of a computing device 1201. As seen in this figure, the computing device 1201 includes a computing unit 1203 with a processing unit 1205 and a system memory 1207. The processing unit 1205 may be any type of programmable electronic device for executing software instructions, but it will conventionally be a microprocessor. The system memory 1207 may include both a read-only memory (ROM) 1209 and a random access memory (RAM) 1211. As will be appreciated by those of ordinary skill in the art, both the read-only memory (ROM) 1209 and the random access memory (RAM) 1211 may store software instructions for execution by the processing unit 1205.

The processing unit 1205 and the system memory 1207 are connected, either directly or indirectly, through a bus 1213 or alternate communication structure, to one or more peripheral devices. For example, the processing unit 1205 or the system memory 1207 may be directly or indirectly connected to one or more additional memory storage devices, such as a “hard” magnetic disk drive 1215, a removable magnetic disk drive 1217, an optical disk drive 1219, or a flash memory card 1221. The processing unit 1205 and the system memory 1207 also may be directly or indirectly connected to one or more input devices 1223 and one or more output devices 1225. The input devices 1223 may include, for example, a keyboard, a pointing device (such as a mouse, touchpad, stylus, trackball, or joystick), a scanner, a camera, and a microphone. The output devices 1225 may include, for example, a monitor display, a printer and speakers. With various examples of the computing device 1201, one or more of the peripheral devices 1215-1225 may be internally housed with the computing unit 1203. Alternately, one or more of the peripheral devices 1215-1225 may be external to the housing for the computing unit 1203 and connected to the bus 1213 through, for example, a Universal Serial Bus (USB) connection.

With some implementations, the computing unit 1203 may be directly or indirectly connected to one or more network interfaces 1227 for communicating with other devices making up a network. The network interface 1227 translates data and control signals from the computing unit 1203 into network messages according to one or more communication protocols, such as the transmission control protocol (TCP) and the Internet protocol (IP). Also, the network interface 1227 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 1201 is illustrated as an example only, and it is not intended to be limiting. Various embodiments of the disclosed technology may be implemented using one or more computing devices that include the components of the computing device 1201 illustrated in FIG. 12, which include only a subset of the components illustrated in FIG. 12, or which include an alternate combination of components, including components that are not shown in FIG. 12. For example, various embodiments of the disclosed technology may be implemented using a multi-processor computer, a plurality of single and/or multiprocessor computers arranged into a network, or some combination of both.

### Conclusion

Having illustrated and described the principles of the disclosed technology, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only preferred examples of the technologies and should not be taken as limiting the scope of the disclosed technology. Rather, the scope of the disclosed technology is defined by the following claims and their equivalents. We therefore claim as our disclosed technology all that comes within the scope and spirit of these claims.

1. A circuit, comprising:
a random number generator configured to generate a random number;
hashing circuitry configured to mimic a hashing function that can transform the random number into a hash value; and
retrieving circuitry configured to use the hash value to retrieve one or more configuration masks from a response signal received by the circuit,
wherein the response signal is generated based on the random number by a computing device, the generating comprising: generating the hash value for the random number, and combining the hash value with the one or more configuration masks.

2. The circuit recited in claim 1, further comprising:
a controller configured to supervise an authentication process, the authentication process comprising:
generating the random number by the random number generator,
converting the random number into the hash value by the hashing circuitry, and
retrieving, by the retrieving circuitry, the one or more configuration masks from the response signal received by the circuit based on the hash value.

3. The circuit recited in claim 2, wherein the controller is further configured to supervise a self-testing process.

4. The circuit recited in claim 2, wherein the controller comprises a finite state machine.

5. The circuit recited in claim 1, further comprising:
a descrambler configured to use a configuration mask in the one or more configuration masks to descramble a signal received by the circuit.

6. The circuit recited in claim 5, wherein the descrambling the signal comprises retrieving compressed test patterns from encrypted compressed test patterns received by the circuit.

7. The circuit recited in claim 6, wherein the compressed test patterns are transported in the circuit through a data bus.

8. The circuit recited in claim 1, further comprising:
a scrambler configured to use a configuration mask in the one or more configuration masks to scramble a signal to be sent out by the circuit.

9. The circuit recited in claim 8, wherein the scrambling the signal comprises encrypting compacted test responses before being sent out by the circuit.

10. The circuit recited in claim 1, wherein the random number generator comprises:
a ring generator; and
one or more inverter-based ring oscillators, the one or more inverter-based ring oscillators configured to inject bits into the ring generator at a plurality of location.

11. The circuit recited in claim 10, wherein the random number generator further comprises:
blocking circuitry configured to convert, based on a blocking signal, the ring generator into a circular shift register by blocking both the injection from the one or more inverter-based ring oscillators and internal feedbacks in the ring generator.

12. The circuit recited in claim 10, wherein at least one of the one or more inverter-based ring oscillators is configured to inject bits from outputs of some or all inverting elements in the at least one of the one or more inverter-based ring oscillators.

13. The circuit recited in claim 10, wherein if the one or more inverter-based ring oscillators have more than one inverter-based ring oscillators, the one or more inverter-based ring oscillators have different numbers of inverting elements and inject bits into the ring generator at different locations.

14. The circuit recited in claim 1, wherein the hashing circuitry comprises:
combinational circuitry comprising nonlinear Boolean operators formed by logic gates, the combinational circuitry configured to receive the random number; and
a ring generator configured to be initialized by a secret key, to be injected with bits from outputs of the combinational circuitry, and to output the hash value after a predefined number of clock cycles.

15. The circuit recited in claim 1, wherein the retrieving circuitry comprises XOR gates.

16. One or more computer-readable media storing computer-executable instructions for causing a computer to perform a method, the method comprising:
creating, in a circuit design, a circuit, the circuit comprising:
a random number generator configured to generate a random number;
hashing circuitry configured to mimic a hashing function that can transform the random number into a hash value; and
retrieving circuitry configured to use the hash value to retrieve one or more configuration masks from a response signal received by the circuit,
wherein the response signal is generated based on the random number by a computing device, the generating comprising: generating the hash value for the random number, and combining the hash value with the one or more configuration masks.

17. The one or more non-transitory computer-readable media recited in claim 16, wherein the circuit further comprises:
a controller configured to supervise an authentication process, the authentication process comprising:
generating the random number by the random number generator,
converting the random number into the hash value by the hashing circuitry, and
retrieving, by the retrieving circuitry, the one or more configuration masks from the response signal received by the circuit based on the hash value.

18. The one or more non-transitory computer-readable media recited in claim 16, wherein the circuit further comprises:
a descrambler configured to use a configuration mask in the one or more configuration masks to descramble a signal received by the circuit.

19. The one or more non-transitory computer-readable media recited in claim 16, wherein the random number generator comprises:
a ring generator; and
one or more inverter-based ring oscillators, the one or more inverter-based ring oscillators configured to inject bits into the ring generator at a plurality of location.

20. The one or more non-transitory computer-readable media recited in claim 19, wherein the random number generator further comprises:
blocking circuitry configured to convert, based on a blocking signal, the ring generator into a circular shift register by blocking both the injection from the one or more inverter-based ring oscillators and internal feedbacks in the ring generator.

21. The one or more non-transitory computer-readable media recited in claim 19, wherein at least one of the one or more inverter-based ring oscillators is configured to inject bits from outputs of some or all inverting elements in the at least one of the one or more inverter-based ring oscillators.

22. The one or more non-transitory computer-readable media recited in claim 16, wherein the hashing circuitry comprises:
combinational circuitry comprising nonlinear Boolean operators formed by logic gates, the combinational circuitry configured to receive the random number; and
a ring generator configured to be initialized by a secret key, to be injected with bits from outputs of the combinational circuitry, and to output the hash value after a predefined number of clock cycles.
